(19) United States
(12) Patent Application Publication
(10) Pub. No.: US 2017/0032707 A1
(43) Pub. Date: Feb. 2, 2017

(54) METHOD FOR DETERMINING A FRUITION SCORE IN RELATION TO A POVERTY ALLEVIATION PROGRAM

(71) Applicant: MasterCard International Incorporated, Purchase, NY (US)

(72) Inventors: Suneel Bhatt, Delhi (IN); Ankur Arora, New Delhi (IN); Priyanka Taneja, Gurgaon (IN)

(21) Appl. No.: 15/200,436

(22) Filed: Jul. 1, 2016

(30) Foreign Application Priority Data
Jul. 27, 2015 (SG) 10201505842V

(51) Int. Cl. G09B 29/00; G09B 5/02

(52) U.S. Cl. CPC G09B 29/007; G09B 29/005; G09B 5/02

(57) ABSTRACT

Disclosed in a method for determining a fruition score in relation to a poverty alleviation program. The method includes selecting a geographical region on the basis that the poverty alleviation program is implemented in the geographical region for at least part of an analysis period. A processor is then used to determine, from a first data set stored in a memory device, a plurality of first data subsets applicable to the geographical region for a first period of time, the first period of time being at a commencement of the analysis time period. The processor subsequently determines, from a second data set stored in the memory device, a plurality of second data subsets applicable to the geographical region for a second period of time, the second period of time being at an end of the analysis time period.

### CROSS-REFERENCE TO RELATED APPLICATION

This application is a U.S. National Stage filing under 35 U.S.C. §119, based on and claiming benefit of and priority to SG Patent Application No. 10201505842V filed Jul. 27, 2015.

### TECHNICAL FIELD

The present disclosure relates to systems and methods for ascertaining the efficacy of poverty alleviation programs. In particular, the present disclosure relates to systems and methods for determining a fruition score in relation to a poverty alleviation program.

### BACKGROUND

Around the world, nearly 3 billion people are living in poverty. Of those people, around 1 billion are children and around 1.2 billion live in extreme poverty.

Due to the size of the poverty crisis there are many hundreds of poverty alleviation programs have been implemented by governments and aid organisations. These programs usually aim to deliver education, and daily necessities such as food and water, into poverty stricken areas in an endeavour to bring those areas out of poverty.

Due to the scale of the crisis, the number of programs concurrently implemented, and the inaccuracy of population statistics (e.g. census data) for many remote areas experiencing poverty, the success or otherwise of poverty alleviation programs is difficult to ascertain. There is also difficulty in ascertaining whether any apparent improvement in socio-economic circumstances in a particular region is the result of significant economic improvement for a small proportion of the population, or whether the improvement is more broadly applicable to the general populace—improvement to the circumstances of the general populace being generally preferred over the improved financial circumstances of a few individuals or organisations.

Governments and aid organisations would like to focus their efforts and finances on projects that are likely to succeed, and to continue to fund those programs that have shown promising results. It is desired, therefore, to establish the success of aid programs on improving the socio-economic standing of particular regions and socio-demographics.

### SUMMARY

In accordance with the present disclosure, there is provided a method for determining a fruition score in relation to a poverty alleviation program, the method comprising:

selecting a geographical region on the basis that the poverty alleviation program is implemented in the geographical region for at least part of an analysis period;

using a processor to determine, from a first data set stored in a memory device, a plurality of first data subsets applicable to the geographical region for a first period of time, the first period of time being at a commencement of the analysis time period;

using a processor to determine, from a second data set stored in the memory device, a plurality of second data subsets applicable to the geographical region for a second period of time, the second period of time being at an end of the analysis time period,
wherein the plurality of second data subsets comprise representative second data corresponding to representative first data in the plurality of first data subsets, and
wherein data from at least one first data subset and at least one second data subset comprises financial transaction data including latitude and longitude coordinates for financial transactions within the geographical region during the analysis period;

using the processor to determining the fruition score based on a divergence of the representative second data from the representative first data; and displaying the fruition score, in association with the geographical region, on a display to facilitate visual recognition of an impact of the poverty alleviation program.

In accordance with the present disclosure, there is provided a computer system for determining a fruition score in relation to a poverty alleviation program, the computer system comprising:

a memory device for storing data;

a display; and

a processor coupled to the memory device and being configured to:
select a geographical region on the basis that the poverty alleviation program is implemented in the geographical region for at least part of an analysis period;
determine, from a first data set, a plurality of first data subsets applicable to the geographical region for a first period of time, the first period of time being at a commencement of the analysis time period;
determine, from a second data set, a plurality of second data subsets applicable to the geographical region for a second period of time, the second period of time being at an end of the analysis time period,
   wherein the plurality of second data subsets comprise representative second data corresponding to representative first data in the plurality of first data subsets, and
   wherein data from at least one first data subset and at least one second data subset comprises financial transaction data including latitude and longitude coordinates for financial transactions within the geographical region during the analysis period;
determine the fruition score based on a divergence of the representative second data from the representative first data; and
   display the fruition score, in association with the geographical region, on the display.

In accordance with the present disclosure, there is provided a computer program embodied on a non-transitory computer readable medium for determining a fruition score in relation to a poverty alleviation program, the program comprising at least one code segment executable by a computer to instruct the computer to:
select a geographical region on the basis that the poverty alleviation program is implemented in the geographical region for at least part of an analysis period;
determine, from a first data set, a plurality of first data subsets applicable to the geographical region for a first period of time, the first period of time being at a commencement of the analysis time period;
determine, from a second data set, a plurality of second data subsets applicable to the geographical region for a second period of time, the second period of time being at an end of the analysis time period,
   wherein the plurality of second data subsets comprise representative second data corresponding to representative first data in the plurality of first data subsets, and
   wherein data from at least one first data subset and at least one second data subset comprises financial transaction data including latitude and longitude coordinates for financial transactions within the geographical region during the analysis period;
determine the fruition score based on a divergence of the representative second data from the representative first data; and
   display the fruition score, in association with the geographical region, on a display.

In accordance with the present disclosure, there is provided a network-based system for determining a fruition score in relation to a poverty alleviation program, the system comprising:

a client computer system;

at least one database;

a display; and

a server system coupled to the client computer system and the database, the server system configured to:
receive from the client computer system a selection of a geographical region, the selection being based on the poverty alleviation program being implemented in the geographical region for at least part of an analysis period;
determine, from a first data set stored in the at least one database, a plurality of first data subsets applicable to the geographical region for a first period of time, the first period of time being at a commencement of the analysis time period;
determine, from a second data set stored in the at least one database, a plurality of second data subsets applicable to the geographical region for a second period of time, the second period of time being at an end of the analysis time period,
   wherein the plurality of second data subsets comprise representative second data corresponding to representative first data in the plurality of first data subsets, and
   wherein data from at least one first data subset and at least one second data subset comprises financial transaction data including latitude and longitude coordinates for financial transactions within the geographical region during the analysis period;
determine the fruition score based on a divergence of the representative second data from the representative first data; and
   display the fruition score, in association with the geographical region, on the display.

In the present disclosure, the following terms will have the meaning stated here unless context dictates otherwise:
“representative data” defines parameter relating to geographical region. In the present instance, the representative data includes one or more data elements each of which defines a socio-economic indicator relating to the geographical region.
“divergence” refers to the difference in a value of a data element from the representative second data in the second data set when compared with the value of the corresponding data element from the representative first data.
“relating to a geographical region” means relating to the geographical region as a whole—e.g. a country or state. This is to be contrasted with “relating to a geographical subregion”, meaning relating to only a subregion of the geographical region—e.g. a state or territory, where the geographical region is a country, or a city, where the geographical region is a state or territory.
“fruition score” is a measure of the success of a poverty alleviation program applied to a particular geographical region. The fruition score may be based on a relative change (e.g. increase) in the average food spend in the geographical region, mobile telephone usage and other measures that can be used to infer the amount of income for a particular person or population in the geographical region. From an improvement in income, a lessened state of poverty can be inferred.
“poverty alleviation program” is a program applied by, for example, a government or aid organisation to improve the living standard of people in a particular geographic region. The living standard may be determined by a socio-economic status of the people in the geographical region.
“socio-economic status” is a financial measure used to infer the relative poverty of people. It may, for example, define whether a particular person or population of a geographical region earn less than a dollar amount (or its equivalent) determined by the World Health Organisation to define a poverty threshold, an extreme poverty threshold and so forth.
“subregion-specific indicators” or “socio-economic indicators” are data elements (i.e. pieces of data) from which the relative poverty of a person or population can be inferred.
“relative poverty” is a term used to describe the poverty of a particular person or population when compared with the poverty of those around them. In more affluent societies there may still be people without access to proper sources of food or education and have a worse standard of living than those earning less money and living in poorer areas where food and education are comparatively cheaper.

### BRIEF DESCRIPTION OF THE DRAWINGS

Some systems and methods for determining a fruition score relating to a poverty alleviation program will now be described, by way of non-limiting example only, with reference to the accompanying drawings in which:

FIG. 1 is a schematic flow diagram of a method for determining a fruition score in accordance with the present disclosure;

FIG. 2 shows a geographical map divided into subregions each of which has been shaded in accordance with a value of a subregion-specific indicator;

FIG. 3 is a schematic flow diagram of another method for determining a fruition score in accordance with the present disclosure;

FIG. 4 is a high level schematic overview of a data collection regime for formulating first and second data sets as described herein;

FIG. 5 illustrates the transfer of data in accordance with the regime illustrated in FIG. 4, for generating a socio-economic map (i.e. a graphical map with a visual overlay based on the fruition score);

FIG. 6 is an expanded block diagram of an exemplary embodiment of a server architecture of a computer system for determining a fruition score; and

FIG. 7 illustrates an exemplary configuration of a server system shown in FIG. 6.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Although the systems and methods described herein can be used on a variety of different types of data, the exemplary data described herein will be a combination of population data, financial data and communications data. The data in question can make it possible to infer a socio-economic status of a person or population, and to that end such data can be referred to as socio-economic indicators or subregion-specific indicators. This is particularly the case for data elements comprising part of the representative first data or representative second data described herein.

The data presented herein will usually be one of three types of data: population data, financial data and communications data. Each data set can comprise a plurality of subsets of data relating to one or more data types.

Where a data set or subset comprises population data for a particular geographical region, each data element in that data set or subset comprises a value representing at least one of population statistics, religion statistics, individual income distribution, household income statistics, nationality of individuals in the geographical region and race of individuals among others. Information collected by a census, by a government agency or data collection agency can often be considered to be population data.

Where a data set or subset comprises financial data, each data element in that data set or subset comprises at least one of average automated teller machine (ATM) withdrawal size in a geographical region, average ticket size for purchases made in the geographical region, average spend on food in the geographical region and social security stamp usage in the geographical region. Financial data may also include financial transaction data including latitude and longitude coordinates for financial transactions within the geographical region during the analysis period.

Where a data set or subset comprises communications data, each data element in that data set or subset comprises at least one of mobile telephone recharge frequency in a geographical region, average mobile recharge amount in the geographical region, average number of calls made over a predetermined period in the geographical region and internet usage in the geographical region.

It will further be understood that some of the above socio-economic or subregion-specific indicators will be established over a period of time: For example, average spend on food or mobile telephone usage should be collected over a period of time to ensure the collected information is not an outlier.

The systems and methods disclosed herein are applied in relation to geographical regions in which a poverty alleviation program is running, has run or is intended to be run. A particular geographical region may be shown to be suitable for receiving a poverty alleviation by analysing multiple geographical regions that meet one or more poverty related requirements, such as average daily household income being at or lower than a particular threshold, and selecting an appropriate candidate region from the multiple geographical regions. The selection may depend on the likelihood of success of the poverty alleviation program. Determining likelihood of success may involve analysis of the potential for local government for the geographical region to seize funds and aid delivered to the region. Determining likelihood of success may involve analysing historical data for similar poverty alleviation programs and geographical regions with similar characteristics (e.g. population size, climate, average household income) and selecting a geographical region for which success of the poverty alleviation program is likely based on historical data.

Unless otherwise specified, reference to a method step is intended to also infer program code capable of causing a computer to executed that method step, and thus also to a computer system capable of performing the method step.

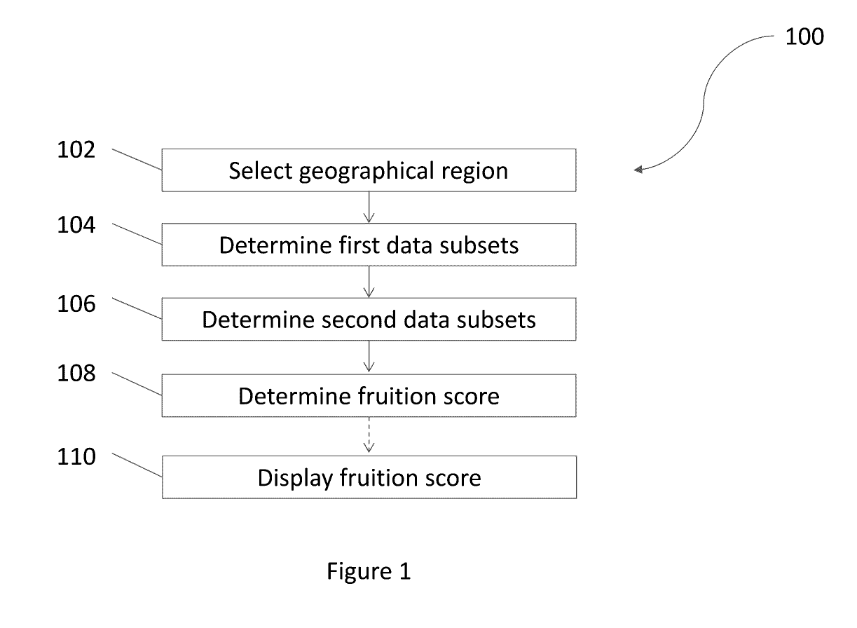

FIG. 1 depicts the steps in a method 100 method for determining a fruition score in relation to a poverty alleviation program. The poverty alleviation program is applied to a geographical region and the success of the program should thus be identifiable by an improvement in socio-economic circumstances or status or people and populations in the geographical region.

The first step 102 is therefore to identify or select a geographical region on the basis that the poverty alleviation program is implemented in the geographical region for at least part of an analysis period. The analysis period is the period over which the success or otherwise of the poverty alleviation program is assessed.

The poverty alleviation program may commence before the commencement of the analysis period. The analysis period may instead be selected to commence at the time of implementation of the poverty alleviation program. The poverty alleviation program may instead commence after the commencement of the analysis period but sufficiently in advance of the end of the analysis period that a fruition score for the poverty alleviation program can be calculated.

To determine the fruition score of the poverty alleviation program requires collection of data. A first data set is collected at the commencement of the analysis time period. The first data set contains data such as population, financial and communications data. A second data set is collected at the end of the analysis time period.

A plurality of first data subsets are then determined 104 such that the data of each first subset applies to the geographical region for the first period of time (i.e. at the commencement of the analysis period). A plurality of second data subsets are then determined 106 such that the data of each second subset applies to the geographical region for the second period of time (i.e. at the end of the analysis period).

Each of the second subsets is determined such that it contains representative second data (i.e. representative data from one of the second subsets) that corresponds to representative first data in a respective first subset. This is so that changes in data can be tracked—for example, changes can be tracked if population numbers, mobile phone usage, ATM withdrawal frequency and average ticket amount (i.e. average purchase transaction amount) at the first time period are respectively compared with population numbers, mobile phone usage, ATM withdrawal frequency and purchase ticket amount at the second time period. This is as opposed to trying to determine success of a program by comparing disparate or incomparable measures—for example, trying to determine the success of a poverty alleviation program by analysing the sales of wheat at the first period of time and domestic vehicle tyre usage at the second period of time.

The fruition score may be more readily packaged for usage by aid program providers if the representative data comes from a particular field—for example, population data, financial data or communications data. To facilitate separation of the data into those fields, each of the plurality of second data subsets can be determined such that the representative second data for each one of the second data subsets corresponds to the first representative data for a unique one of the first data subsets. As such, the fruition score may include multiple fruition subscores being a fruition score applicable to one or more first data subset/second data subset pairs.

After identifying relevant subsets, a fruition score is determined 108. The fruition score is determined based on a divergence of the representative second data from the representative first data. Divergence may be the difference between a data element at the first period of time when compared with a similar data element at the second period of time. That difference can be defined in any appropriate way, including a difference in absolute terms, in ratio terms, as a percentage and so on. For example, if a data element from the first data set is 3 (e.g. $3 for the average ticket size at a first point in time) and a comparable data element from the second data set is 9 (e.g. $9 for the average ticket size at a second, later point in time), the difference, in absolute terms, between 3 and 9 will be 6, in ratio terms it will be 3, in percentage terms it will be 300% in size or 200% growth and so on.

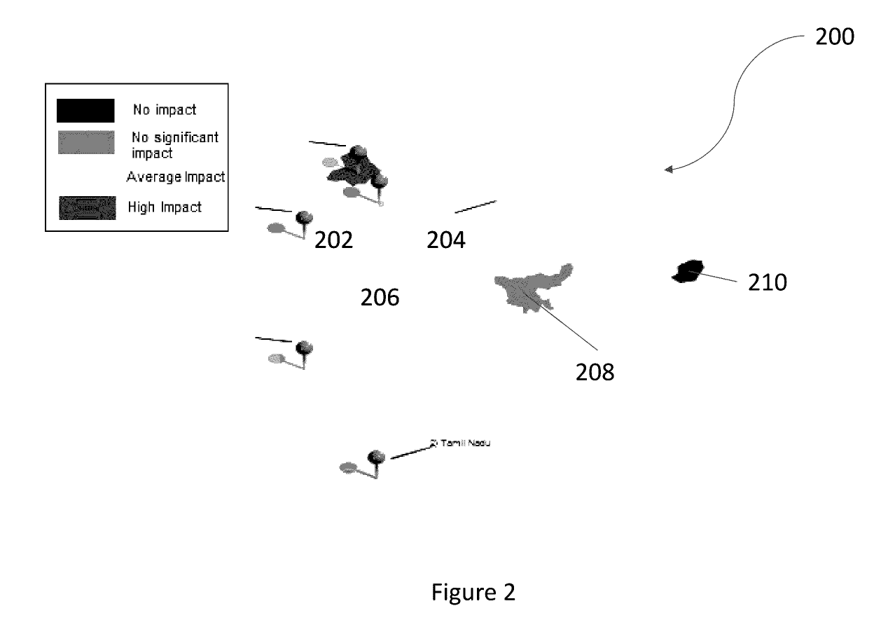

Once determined, the fruition score can be displayed on a display 110. To facilitate easy dissemination of data represented by the fruition score to various parties in an understandable form, the fruition score may be displayed as an overlay to a geographical map comprising the geographical region (see FIG. 2). This map may be termed a “socio-economic map” since it is developed on the basis of data representative of indicators of the socio-economic status of a person, community or population.

With reference to FIG. 2, to gain finer resolution as to the success of a poverty alleviation program over a large geographical region 200, the fruition score may comprise a plurality of subregion-specific indicators. Each subregion-specific indicator can be used to indicate a subregion-specific fruition score for a unique subregion of the geographical region—see, e.g. subregions 202, 204, 206, 208, 210.

The subregion-specific indicators are thus comparable to the fruition score but determined as though the geographical region were the geographical subregion represented by the subregion-specific indicator.

As a result, a number of overlays can be provided where, for example, a fruition score relates to a particular first data subset/second data subset pair and is decomposed into a plurality of subregion-specific indicators. Also, the fruition score may instead be displayed, in association with the geographical region (which includes subregion-specific indicators displayed in association with their respective subregions of the geographical region), in another manner such as a table with regions listed against their respective subregion-specific indicators.

It will be appreciated that the cost of living, the availability of goods, the proliferation of new electronic products and so forth changes over time. Increases in consumption of goods can be an indicator of improved living conditions. However, increases in consumption of goods can also simply be indicative of an en masse increase in general consumption across the world, or poverty stricken and non-poverty stricken geographical regions, and thus not be indicative of improved living conditions.

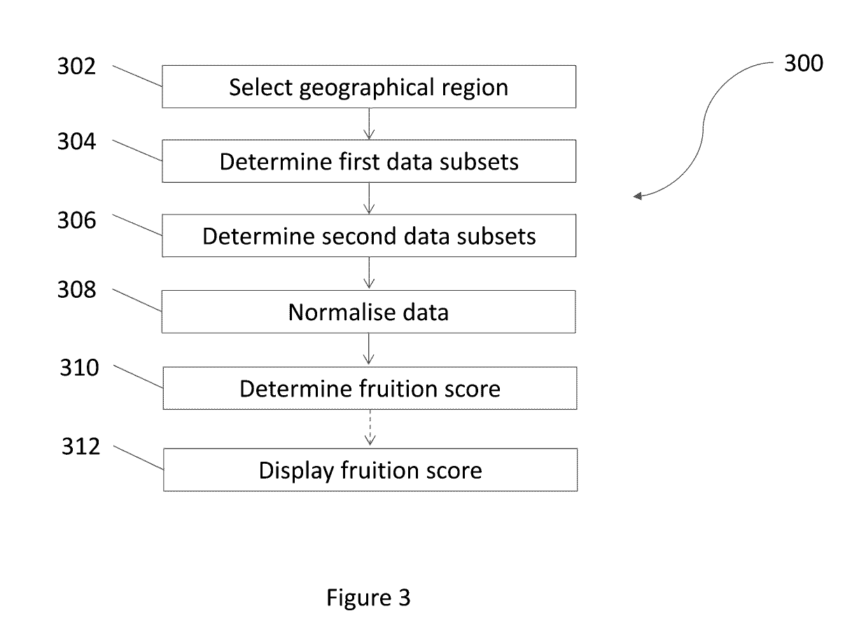

With reference to FIG. 3, to make the fruition score more accurate the data can be normalised. Steps 302, 304 and 306 are comparable to steps 102, 104 and 106 and will thus not be described anew. The method 300 in FIG. 3 involves the receipt of normalising data after determination of the first and second subsets and using that normalising data to normalise the divergence of data in the second data set from data in the first data set 308.

The normalising data relates to the analysis time period such that it can remove some of the ‘noise’ or error associated with underlying broader changes in the world when compared with changes occurring as a result of the poverty alleviation program.

The normalising data can include inflation statistics relating to inflation occurring during the analysis period. The inflation statistics may apply to the geographical region. The inflation statistics may alternatively apply to a broader region, or even to the world as a whole.

The normalising data may alternatively, or in addition, include human migration statistics with respect to migration into, and out of, the geographical region during the analysis period, or any other appropriate normalising information.

Once received, the amount of divergence of data in the second data subset can be determined by normalising the difference between the data in the second data subset and the data in the first data subset. This can be achieved using the equation:

$${d}_{n} = {\sum }_{i = 1}^{M} {w}_{i} ( {r}_{{2}_{i}} - {r}_{{1}_{i}} ) \text{/} {n}_{i}$$

wherein M is the number of data elements making up the representative first data for which there is a corresponding data element in the representative second data, dₙ is the normalised divergence, r₁ᵢ is the i^{th} data element from the representative first data, r₂ᵢ is the data element from the representative second data corresponding to the i^{th} data element from the representative first data, nᵢ is an i^{th} data element in the normalisation data which corresponds to the data element from the representative second data that itself corresponds to the i^{th} data element from the representative first data, and wᵢ is a weighting applied to the i^{th} data element from the representative second data.

To illustrate use of these variables, the values of r₁_{₁} and r₂_{₁} may be the average grocery spend by a particular population at the first period of time and second period of time respectively. Similarly, the values of r₁_{₂} and r₂_{₂} may be average mobile internet data usage per capita at the first period of time and second period of time respectively, and n₁ and n₂ may be the average global increase in grocery prices and average global decrease in mobile internet data cost, respectively, at the second period of time when compared with the first period of time (i.e. expressed as a percentage or ratio). Where grocery cost represents a primary concern of the poverty alleviation program, or constitutes a significantly higher proportion of income, the weighting w₁ for the grocery measures may be set to “1”, whereas the weighting w₂ for the mobile internet usage may be set to “0.2”, for example. Thus the internet usage statistics will be markedly deemphasised, though not entirely removed (this is also an option), when determining overall divergence and thus the fruition score for the poverty alleviation program.

Thus the fruition score may be determined 310 based on a normalised divergence of the representative second data from the representative first data. This normalised divergence can then be displayed 312 in the same manner as the display of non-normalised divergence discussed in relation to the method of FIG. 1 and as displayed in FIG. 2.

Various other equivalent equations and methods exists for normalising data and all such equations and methods are intended to fall within the scope of the present disclosure.

To use the above methods it is important to have data against which the success of a poverty alleviation program can be tested. To this end, the first data subsets may include a first population data subset comprising population data for the geographical region. Similarly, the plurality of second data subsets may include a second population data subset comprising population data for the geographical region. The plurality of first data subsets may also include a first financial data subset comprising financial data for the geographical region, and the plurality of second data subsets may similarly include a second financial data subset comprising financial data for the geographical region. Alternatively, or in addition, the plurality of first data subsets may include a first communications data subset comprising communications data for the geographical region, and the plurality of second data subsets may include a second communications data subset comprising communications data for the geographical region.

If the poverty alleviation program is highly targeted, or to narrow the analysis of the success of the poverty alleviation program, fruition score may relate to a single data element taken at the first period of time and second period of time. For example, the fruition score for a geographical area from which there was mass emigration may take into account only the total population at the first period of time and the total population at the second period of time. Thus the representative first data and the representative second data will each comprise a single data element the value of which indicates the total population for the geographical region.

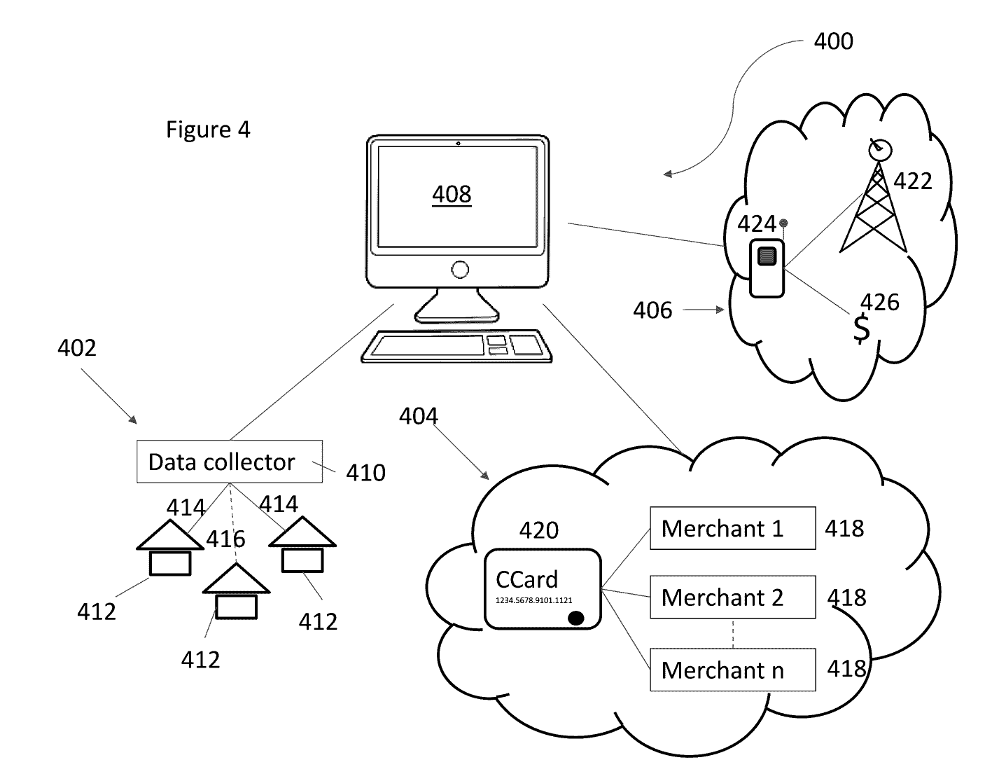

With reference to FIG. 4, the first data subset and second data subset can be composed by assembling data from multiple sources. The data network 400 comprises a population data collection sub-network 402, a financial data collection sub-network 404, a communications data collection sub-network 406 and a computer system 408 (shown here with a display or screen) that receives, wirelessly or otherwise, information from the sub-networks 402, 404, 406.

The population data collection sub-network 402 includes a data collector 410. The data collector may be, for example, a government or census data organisation that is able to obtain population data from households 412 in the geographical region. The solid links 414 indicate reliable acquisition of data from some of the households 412. However, population data for remote and poverty stricken areas is often very difficult to accurately ascertain. For this reason, broken link 416 indicates unreliable or unobtainable data for a particular household.

The financial data collection sub-network 404 includes a plurality of merchants 418 form whom a consumer 420 purchases goods and services. The ticket amount, timing or purchases, location of purchase (e.g. latitude and longitude) and other financial data can be collected when purchases are made.

The communications data collection sub-network 406 comprises communications network equipment 422, personal or business communications devices 424 and also payment gateways 426 that facilitate payment for communications services. The communications data collection sub-network 406 can be used to collect data about internet data usage, mobile telephone usage, pre-paid telephone usage amounts and top-up regularity, progress of communications device sales in the geographical region and so forth. This information can be used to infer changes in connectivity over the analysis period and thus the modernisation of the geographical region.

The data collected from the data sub-networks 402, 404, 406 is sent to the computer system 408 for processing.

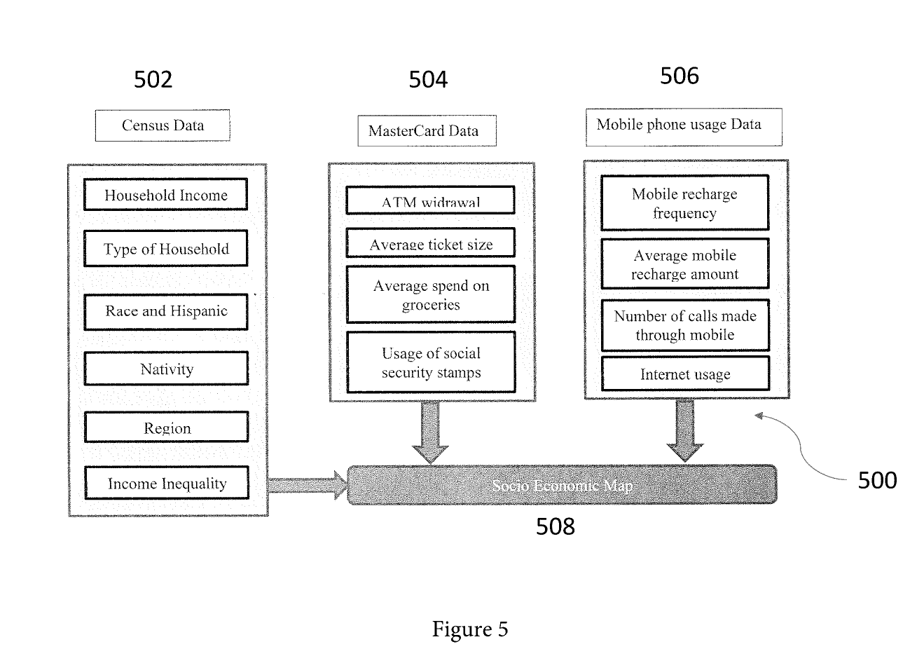

FIG. 5 provides an overview 500 of the progression of data to a computing system, in line with the regime depicted in FIG. 4, for generating a socio-economic map. In other words, from data is used to calculate a fruition score the is used as an overlay to a geographical map of the relevant geographical region to which the fruition score applies, and that geographical map and overlay then form a visual representation of the change in socio-economic status of the geographical region.

Population data, presently census data 502 collected by population data collection sub-network 402 (see FIG. 4), financial data, presently data 504 collected by MasterCard or a financial data collection sub-network 404 (see FIG. 4), and communications data, presently mobile phone usage data 506 collected by communications data collection sub-network 406 (see FIG. 4) are all sent to a computer system 408 (see FIG. 4) for processing. During processing a fruition score is calculated, the fruition score comprising either a single fruition score or be decomposable into a plurality of subregion-specific indicators as discussed above, to facilitate production of a socio-economic map 508.

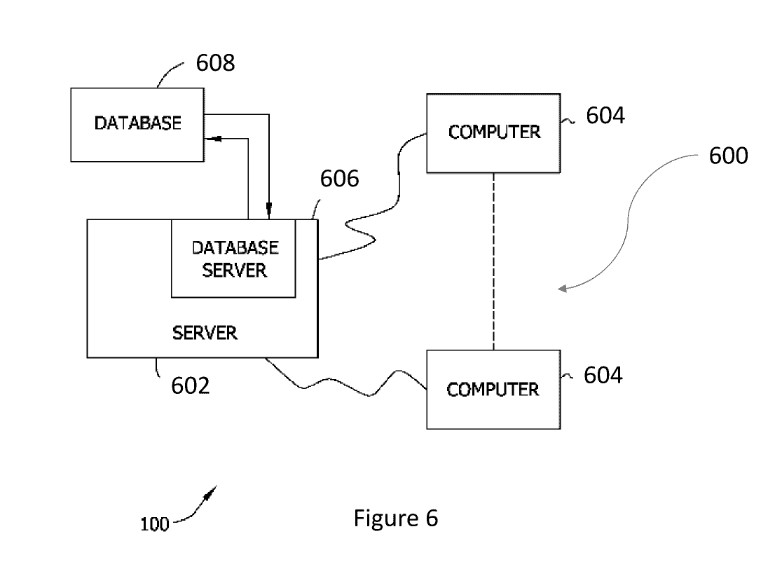

FIG. 6 is a simplified block diagram of an exemplary network-based system 600 used for determining a fruition score relating to a poverty alleviation program. System 600 is a client/server system that may be utilized for storage and delivery of data. More specifically, in the example embodiment, system 600 includes a server system 602, and at least one client computer system. Presently the system 600 includes a plurality of client sub-systems, also referred to as client computer systems 604, connected to server system 602. In one embodiment, client systems 604 are computers including a web browser, such that server system 602 is accessible to client systems 604 using the Internet. Client systems 604 may be interconnected to the Internet through a variety of interfaces including a network, such as a local area network (LAN) or a wide area network (WAN), dial-in-connections, cable modems and special high-speed ISDN lines. Client systems 604 could be any device capable of interconnecting to the Internet including a personal computer (PC), a web-based phone, personal digital assistant (PDA), or other web-based connectable equipment.

A database server 606 is connected to database 608, which contains information the data from which the first data set and second data set can be formed. In one embodiment, centralized database 608 is stored on server system 602 and can be accessed by potential users (e.g. organisations endeavouring to determine a fruition score for one or more poverty alleviation programs applied to one or more geographical regions) at one of client systems 604 by logging onto server system 602 through one of client systems 604. In an alternative embodiment, database 608 is stored remotely from server system 602 and may be non-centralized. Database 608 may store electronic files. Electronic files may include electronic documents, web pages, maps of geographical regions with fruition scores overlaid, other image files and/or electronic data of any format suitable for storage in database 608 and delivery using system 600.

More specifically, database 608 may store financial data, population data and/or communications data collected over network 400 of FIG. 4.

The system 600 may actually be involved in collection of that data. For example, the system 600 may be involved in the provision of financial services over a network and thereby collect data relating to merchants, account holders or customers, developers, issuers, acquirers, purchases made, and services provided by system 600 and systems and third parties with which the system 600 interacts. For example, server system 602 could be in communication with an interchange network.

Similarly, database 608 may also store account data including at least one of a cardholder name, a cardholder address, an account number, and other account identifier. Database 608 may also store merchant data including a merchant identifier that identifies each merchant registered to use the network, and instructions for settling transactions including merchant bank account information. Database 608 may also store purchase data associated with items being purchased by a cardholder from a merchant, and authorization request data.

The database 608 may also be a non-transitory computer readable medium storing or embodying a computer program for determining a fruition score in relation to a poverty alleviation program. The program may include at least one code segment executable by a computer to instruct the computer to perform a method as described herein, for example with reference to FIG. 1 or 3.

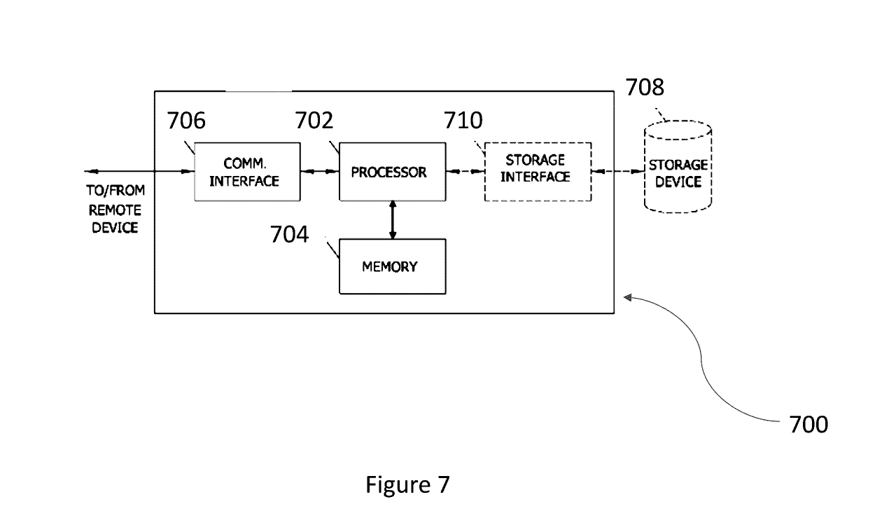

FIG. 7 illustrates an exemplary configuration of a computing device 700, similar to server system 600 (shown in FIG. 6). Computing device 700 may include, but is not limited to, database server, application server, web server, fax server, directory server, and mail server.

Server computing device 700 also includes a processor 702 for executing instructions. Instructions may be stored, for example, in a memory area 704 or other computer-readable media. Processor 702 may include one or more processing units (e.g., in a multi-core configuration).

Processor 702 may be operatively coupled to a communication interface 707 such that server computing device 700 is capable of communicating with a remote device such as user computing device 704 (shown in FIG. 7) or another server computing device 700. For example, communication interface 707 may receive requests from client system 704 via the Internet.

Processor 702 may also be operatively coupled to storage device 708. Storage device 708 is any computer-operated hardware suitable for storing and/or retrieving data. In some embodiments, storage device 708 is integrated in server computing device 700. For example, server computing device 708 may include one or more hard disk drives as storage device 708. In other embodiments, storage device 708 is external to server computing device 700 and may be accessed by a plurality of server computing devices 700. For example, storage device 708 may include multiple storage units such as hard disks or solid state disks in a redundant array of inexpensive disks (RAID) configuration. Storage device 708 may include a storage area network (SAN) and/or a network attached storage (NAS) system.

In some embodiments, processor 700 is operatively coupled to storage device 708 via a storage interface 710. Storage interface 710 is any component capable of providing processor 702 with access to storage device 708. Storage interface 710 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 702 with access to storage device 708.

In operation, the processor 702, coupled to a memory device (including memory device 704 and storage device 708), is configured to select (which includes enabling selection by a user) a geographical region on the basis that the poverty alleviation program is implemented in the geographical region for at least part of an analysis period. The processor is configured to thereafter determine, from a first data set, a plurality of first data subsets applicable to the geographical region for a first period of time, the first period of time being at a commencement of the analysis time period. This process will similarly determine, from a second data set, a plurality of second data subsets applicable to the geographical region for a second period of time, the second period of time being at an end of the analysis time period, wherein the plurality of second data subsets comprise representative second data corresponding to representative first data in the plurality of first data subsets. Using the representative first data and representative second data, the process is configured to determine the fruition score based on a divergence of the representative second data from the representative first data.

The computer system 700 may be instructed to determine the fruition score by a computer program embodied on a non-transitory computer readable medium, such as memory device 704 or storage device 708. The program stored on the device 704 708 would include at least one code segment, and most likely many thousands of code segments, executable by a computer to instruct the computer to perform the requested operations.

Similarly, the program may be stored remotely. To this end, the computer system may constitute a client computer system of a network-based system for determining a fruition score in relation to a poverty alleviation program.

Many modifications and variations of the present teachings will be apparent to the skilled person in light of the present disclosure. All such modifications and variations are intended to fall within the scope of the present disclosure. Moreover, to the extent possible, features form one of the embodiments described herein may be used in one or more other embodiments to enhance or replace a feature of the one or more other embodiments. All such usage, substitution and replacement is intended to fall within the scope of the present disclosure.

1. A method for determining a fruition score in relation to a poverty alleviation program, the method comprising:
selecting a geographical region on the basis that the poverty alleviation program is implemented in the geographical region for at least part of an analysis period;
using a processor to determine, from a first data set stored in a memory device, a plurality of first data subsets applicable to the geographical region for a first period of time, the first period of time being at a commencement of the analysis time period;
using a processor to determine, from a second data set stored in the memory device, a plurality of second data subsets applicable to the geographical region for a second period of time, the second period of time being at an end of the analysis time period,
wherein the plurality of second data subsets comprise representative second data corresponding to representative first data in the plurality of first data subsets, and
wherein data from at least one first data subset and at least one second data subset comprises financial transaction data including latitude and longitude coordinates for financial transactions within the geographical region during the analysis period;
using the processor to determining the fruition score based on a divergence of the representative second data from the representative first data; and
displaying the fruition score, in association with the geographical region, on a display to facilitate visual recognition of an impact of the poverty alleviation program.

2. A method according to claim 1, wherein the plurality of second data subsets are determined by the processor such that the representative second data for each one of the second data subsets corresponds to the first representative data for a unique one of the first data subsets.

3. A method according to claim 1, wherein the fruition score is displayed on the display as an overlay to a geographical map comprising the geographical region.

4. A method according to claim 1, wherein determining the fruition score comprises using the processor to determine a plurality of subregion-specific indicators, each subregion-specific indicator indicating a subregion-specific fruition score for a unique subregion of the geographical region.

5. A method according to claim 4, wherein the fruition score is displayed on the display as an overlay to a geographical map comprising the geographical region by displaying each subregion-specific indicator as an overlay over the respective unique geographical subregion.

6. A method according to claim 1, further comprising receiving normalising data relating to the analysis time period, wherein the step of determining the fruition score based on the divergence of the representative second data from the representative first data comprises using the processor to normalise the divergence using the normalising data and to use the normalised divergence to determine the fruition score.

7. A method according to claim 6, wherein the normalised divergence is determined using the equation:
$${d}_{n} = {\sum }_{i = 1}^{M} {w}_{i} ( {r}_{{2}_{i}} - {r}_{{1}_{i}} ) \text{/} {n}_{i}$$
wherein M is a number of data elements in the representative first data for which there is a corresponding data element in the representative second data, dₙ is the normalised divergence, r₁ᵢ is the i^{th} data element from the representative first data, r₂ᵢ is the data element from the representative second data corresponding to the i^{th} data element from the representative first data, nᵢ is an i^{th} data element in the normalisation data which corresponds to the data element from the representative second data that itself corresponds to the i^{th} data element from the representative first data, and wᵢ is a weighting applied to the i^{th} data element from the representative second data.

8. A method according to claim 6, wherein receiving normalising data comprises receiving inflation statistics relating to inflation occurring during the analysis period.

9. A method according to claim 6, wherein receiving normalising data comprises receiving human migration statistics with respect to migration into, and out of, the geographical region during the analysis period.

10. A computer system for determining a fruition score in relation to a poverty alleviation program, the computer system comprising:
a memory device for storing data;
a display; and
a processor coupled to the memory device and being configured to:
select a geographical region on the basis that the poverty alleviation program is implemented in the geographical region for at least part of an analysis period;
determine, from a first data set, a plurality of first data subsets applicable to the geographical region for a first period of time, the first period of time being at a commencement of the analysis time period;
determine, from a second data set, a plurality of second data subsets applicable to the geographical region for a second period of time, the second period of time being at an end of the analysis time period,
wherein the plurality of second data subsets comprise representative second data corresponding to representative first data in the plurality of first data subsets, and
wherein data from at least one first data subset and at least one second data subset comprises financial transaction data including latitude and longitude coordinates for financial transactions within the geographical region during the analysis period;
determine the fruition score based on a divergence of the representative second data from the representative first data; and
display the fruition score, in association with the geographical region, on the display.

11. A computer system according to claim 10, wherein the processor is configured to determine the plurality of second data subsets such that the representative second data for each one of the second data subsets corresponds to the first representative data for a unique one of the first data subsets.

12. A computer system according to claim 10, wherein the fruition score is displayed as an overlay to a geographical map comprising the geographical region.

13. A computer system according to claim 10, wherein the processor is configured to determine the fruition score by determining a plurality of subregion-specific indicators, each subregion-specific indicator indicating a subregion-specific fruition score for a unique subregion of the geographical region.

14. A computer system according to claim 13, wherein the fruition score is displayed as an overlay to a geographical map comprising the geographical region by displaying each subregion-specific indicator as an overlay over the respective unique geographical subregion.

15. A computer system according to claim 10, wherein the processor is configured to determine the fruition score by normalising the divergence using normalisation data, wherein the first representative data, the second representative data and the normalisation data each comprise a plurality of data elements, and the processor is configured to normalise the divergence according to the equation:
$${d}_{n} = {\sum }_{i = 1}^{M} {w}_{i} ( {r}_{{2}_{i}} - {r}_{{1}_{i}} ) \text{/} {n}_{i}$$
wherein M is a number of data elements in the representative first data for which there is a corresponding data element in the representative second data, dₙ is the normalised divergence, r₁ᵢ is the i^{th} data element from the representative first data, r₂ᵢ is the data element from the representative second data corresponding to the i^{th} data element from the representative first data, nᵢ is an i^{th} data element in the normalisation data which corresponds to the data element from the representative second data that itself corresponds to the i^{th} data element from the representative first data, and wᵢ is a weighting applied to the i^{th} data element from the representative second data.

16. A computer system according to claim 10, wherein the processor is configured to determine the first data subsets and second data subsets such that the representative first data of at least one first data subset, and the corresponding representative second data from a corresponding at least one second data subset, comprises financial transaction data including latitude and longitude coordinates for financial transactions within the geographical region during the analysis period.

17. A computer program embodied on a non-transitory computer readable medium for determining a fruition score in relation to a poverty alleviation program, the program comprising at least one code segment executable by a computer to instruct the computer to:
select a geographical region on the basis that the poverty alleviation program is implemented in the geographical region for at least part of an analysis period;
determine, from a first data set, a plurality of first data subsets applicable to the geographical region for a first period of time, the first period of time being at a commencement of the analysis time period;
determine, from a second data set, a plurality of second data subsets applicable to the geographical region for a second period of time, the second period of time being at an end of the analysis time period,
wherein the plurality of second data subsets comprise representative second data corresponding to representative first data in the plurality of first data subsets, and
wherein data from at least one first data subset and at least one second data subset comprises financial transaction data including latitude and longitude coordinates for financial transactions within the geographical region during the analysis period;
determine the fruition score based on a divergence of the representative second data from the representative first data; and
display the fruition score, in association with the geographical region, on a display.

18. A network-based system for determining a fruition score in relation to a poverty alleviation program, the system comprising:
a client computer system;
at least one database;
a display; and
a server system coupled to the client computer system and the database, the server system configured to:
receive from the client computer system a selection of a geographical region, the selection being based on the poverty alleviation program being implemented in the geographical region for at least part of an analysis period;
determine, from a first data set stored in the at least one database, a plurality of first data subsets applicable to the geographical region for a first period of time, the first period of time being at a commencement of the analysis time period;
determine, from a second data set stored in the at least one database, a plurality of second data subsets applicable to the geographical region for a second period of time, the second period of time being at an end of the analysis time period,
wherein the plurality of second data subsets comprise representative second data corresponding to representative first data in the plurality of first data subsets, and
wherein data from at least one first data subset and at least one second data subset comprises financial transaction data including latitude and longitude coordinates for financial transactions within the geographical region during the analysis period;
determine the fruition score based on a divergence of the representative second data from the representative first data; and
display the fruition score, in association with the geographical region, on the display.
